(19) United States
(12) Patent Application Publication
(10) Pub. No.: US 2003/0109940 A1
(43) Pub. Date: Jun. 12, 2003

(54) Device, storage medium and a method for detecting objects strongly resembling a given object

(76) Inventors: Ulrich Guntzer, Grobenzell (DE); Wolf-Tilo Balke, Augsburg (DE); Werner Kiessling, Augsburg (DE)

Correspondence Address: FULLBRIGHT & JAWORSKI L.L.P., 600 CONGRESS AVE., SUITE 2400, AUSTIN, TX, 78701, US

(21) Appl. No.: 10/203,482

(22) PCT Filed: Feb. 8, 2001
(86) PCT No.: PCT/DE01/00518

(30) Foreign Application Priority Data
Feb. 8, 2000 (EP) 00102651.7

(51) Int. Cl. G05B 19/18; G05B 11/01; G05B 13/02; G05B 15/00

(52) U.S. Cl. 700/52; 700/83; 700/17; 700/2

(57) ABSTRACT

Methods are described with which, from a large number of objects and in an efficient way, a search can be made for the objects which best resemble a sample object. For this purpose, the number of objects to be considered is restricted via efficiently calculated limiting values. In addition, the methods have search strategies which use the values of the characteristics of the objects considered for an efficient search strategy.

The invention relates to methods according to the preamble of patent claims 1, 2, 8, 12, 13, an apparatus for carrying out the methods and a storage medium which can be read by a computer and on which the methods are stored.

A method of determining objects with great similarity to a predefined object is used for example when searching in information systems. The treatment of multimedia data such as images, video or audio data in information systems in which a search is made for objects which correspond with the greatest possible similarity to a predefined object require particularly efficient searching methods because of the complexity of the data and the large quantities of data. During a search evaluation in relation to the similarity to a predefined object, it is not a set of objects which corresponds exactly to the predefined object which is found, instead a set of objects is determined which correspond in a more or less high level of similarity to the predefined object.

An appropriate method is disclosed, for example, by Fagin “Combining Fuzzy Information from Multiple Systems”, 15th ACM Symposium on Principles of Database Systems, pp. 216 to 226, ACM 1996. In this method, from a predefined set of objects which have a predefined number of characteristics, a search is made for the number k of objects which best resemble an object to be predefined, which is designated the sample object in the following text, with predefined characteristics. For this purpose, a search is made through the database in which the objects with the characteristics are stored, and a data list is determined for each characteristic. The data lists are sorted in accordance with decreasing values of the characteristics. The data lists are also designated nuclear output streams. The sample object is defined by values in predefined characteristics. In addition, a combination function is predefined, with which the values of the characteristics of the objects to be compared are assessed in order to obtain information about the most similar objects.

The calculation of the combination function with the characteristics results for each object in a value index which, in the following text, is also designated the aggregated score. The object of the method is, then, to determine the k objects with the highest aggregated scores for the predefined object. The search is carried out in accordance with the following method, using the data lists for the characteristics.

A) In a first step, as many objects from each data list are stored in a memory until at least a number k of identical objects has been stored for each characteristic.

B) In a second step, for each object which has been selected and stored in the data memory, all further characteristics are determined by means of direct accesses to the database. Therefore, after the second step, all the values of the characteristics of the selected objects in the data memory are known.

C) In a third step, the aggregated scores S(x)=F (s₁ (x), . . . , sₙ (x)) are determined for each object x, sᵢ(x) designating the value of the characteristic i of the object x and F designating the combination function and the index variable i being a natural number which satisfies the following condition: 1≦i≦n.

D) Then, in a fourth step, a search is made for the k objects which have the highest aggregated scores, and they are output as a result.

The method according to Fagin is relatively time-consuming, since a large number of objects have to be selected and, for all the objects, direct accesses have to be made to the previously unknown characteristics of the objects. The direct accesses are relatively time-consuming and costly, in particular in heterogeneous information systems.

The object of the invention is to provide a more efficient and quicker method of determining objects which best resemble a predefined object.

The object of the invention is achieved by the features of the independent claims.

One advantage of the invention as claimed in claim 1 is that the value index of the objects is compared with a comparison index and, as a result, the number of objects to be considered is restricted in a simple and efficient manner.

One advantage of the invention as claimed in claim 2 is that only those objects whose values of the characteristics considered lie above a determined limiting value are considered. As a result, the number of objects to be checked is also effectively restricted.

In this way, efficient and quick methods of determining k objects with the greatest similarity to a predefined object are achieved, since fewer objects have to be evaluated.

Further advantageous developments of the invention are specified in the dependent claims.

A particularly efficient method is achieved by the comparison index being calculated with the combination function by using the smallest values of the characteristics of the selected objects.

Further improvement in the methods is achieved by the values of the characteristics of a selected object which have not yet been selected being estimated by means of the smallest values which have already been selected for the corresponding characteristics.

The invention will be explained in more detail below by using the figures, in which:

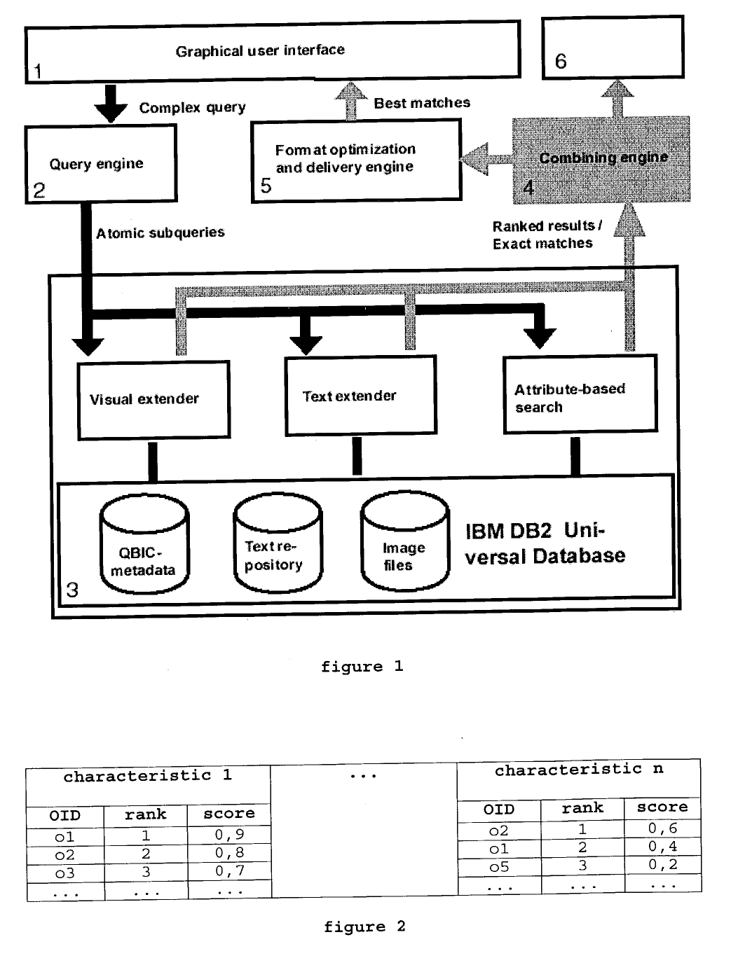

FIG. 1 shows a schematic structure of an information system,

FIG. 2 shows data lists for the characteristics,

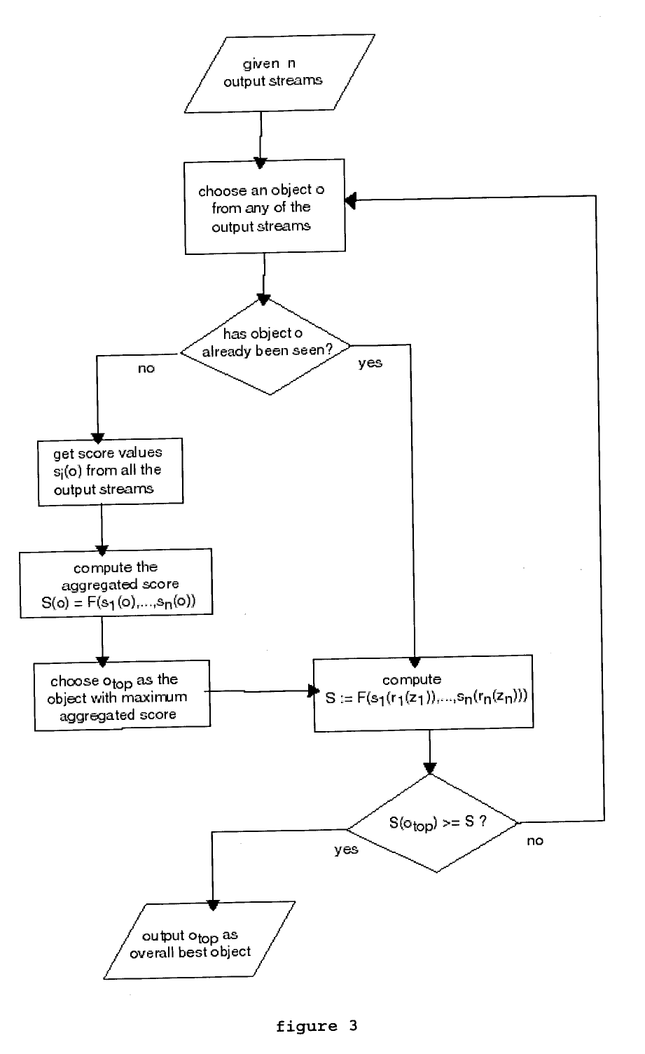

FIG. 3 shows a flowchart for a first algorithm,

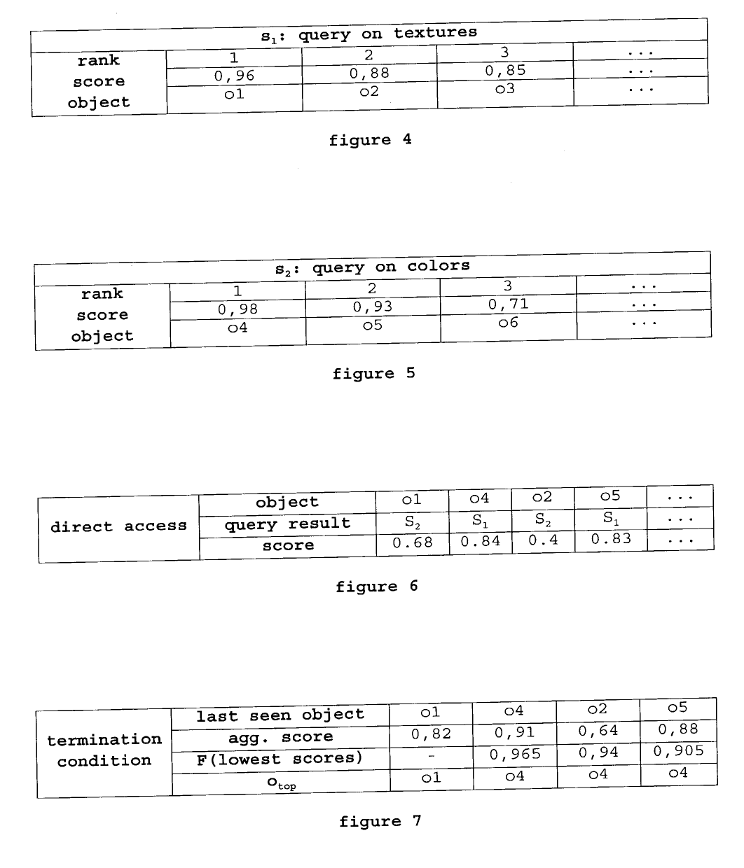

FIG. 4 shows a data list for the texture characteristic,

FIG. 5 shows a data list for the color characteristic,

FIG. 6 shows an access list,

FIG. 7 shows a results list,

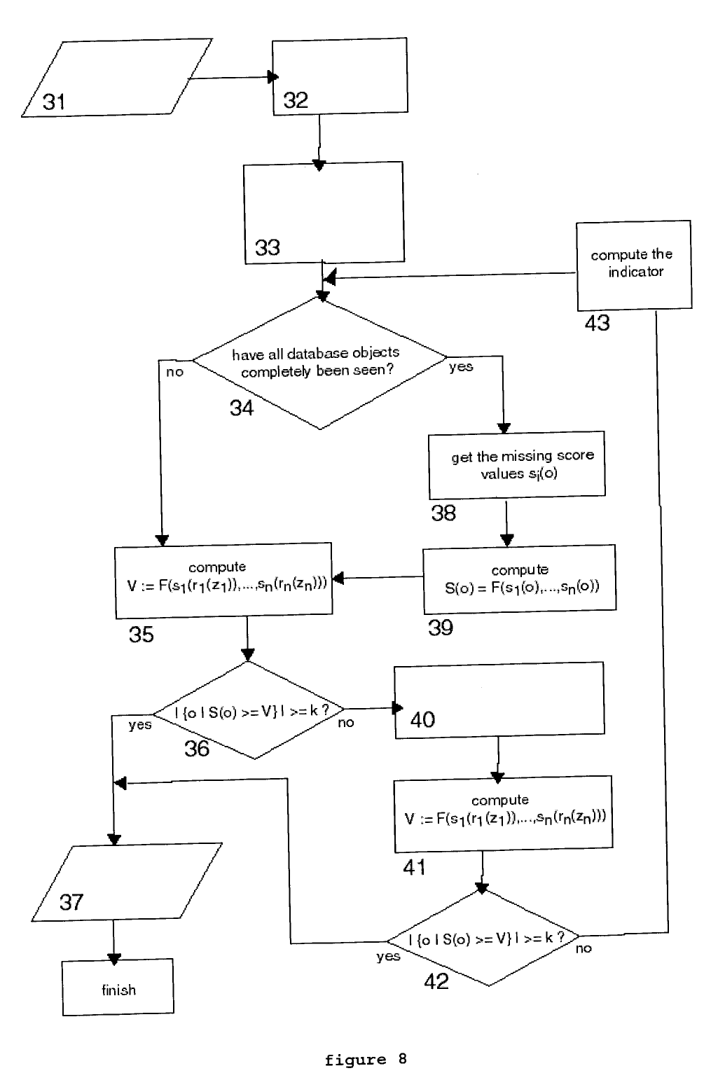

FIG. 8 shows a flowchart for a second algorithm,

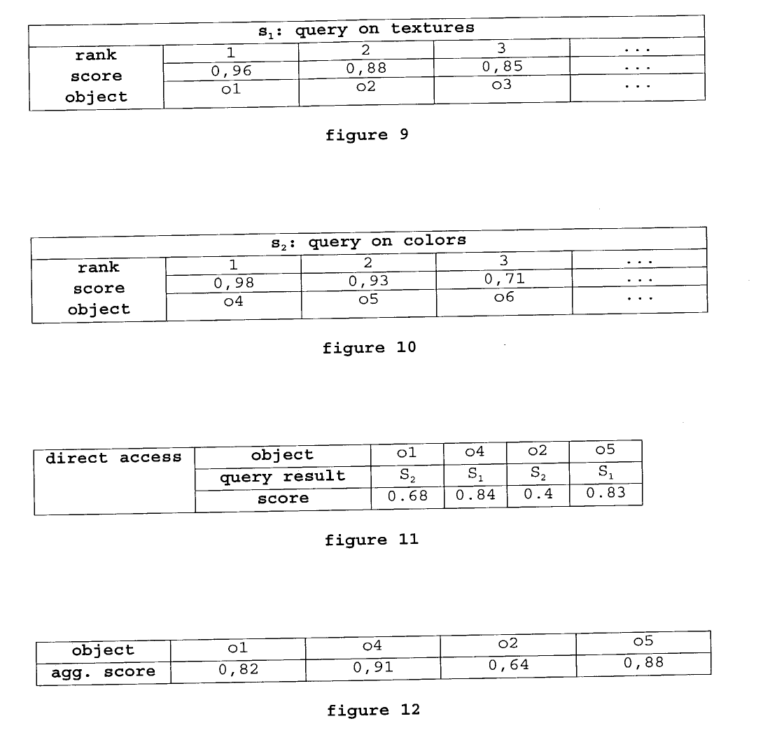

FIG. 9 shows a further data list for the texture characteristic,

FIG. 10 shows a further data list for the color characteristic,

FIG. 11 shows a further access list,

FIG. 12 shows an aggregated score list,

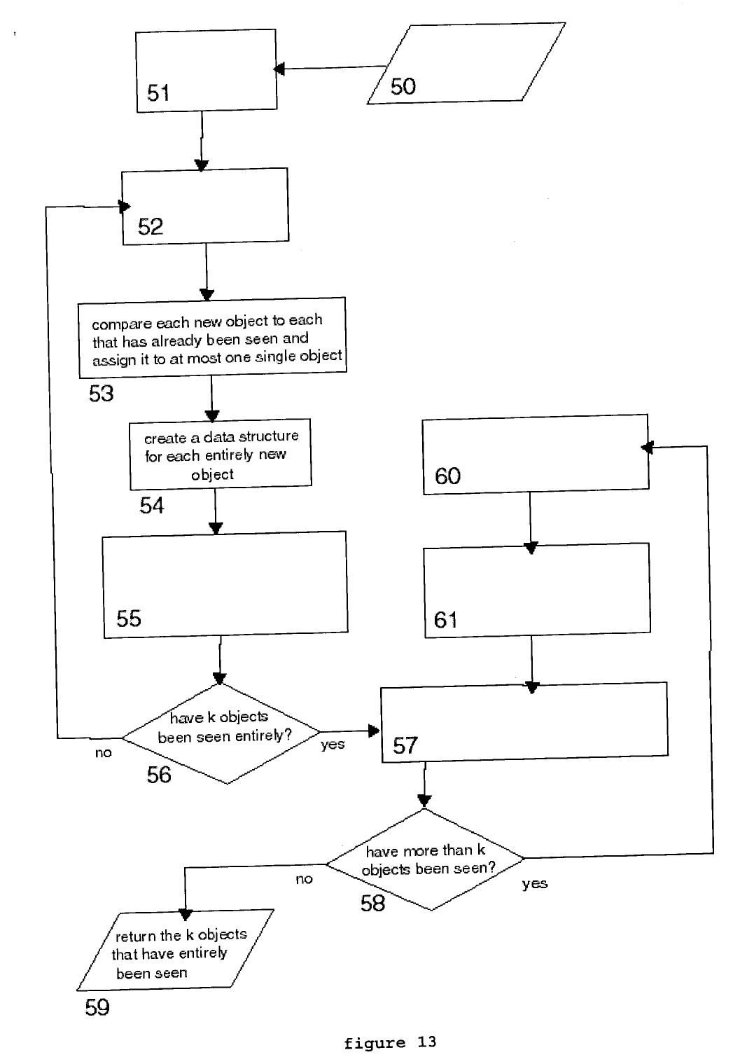

FIG. 13 shows a flowchart for a third algorithm,

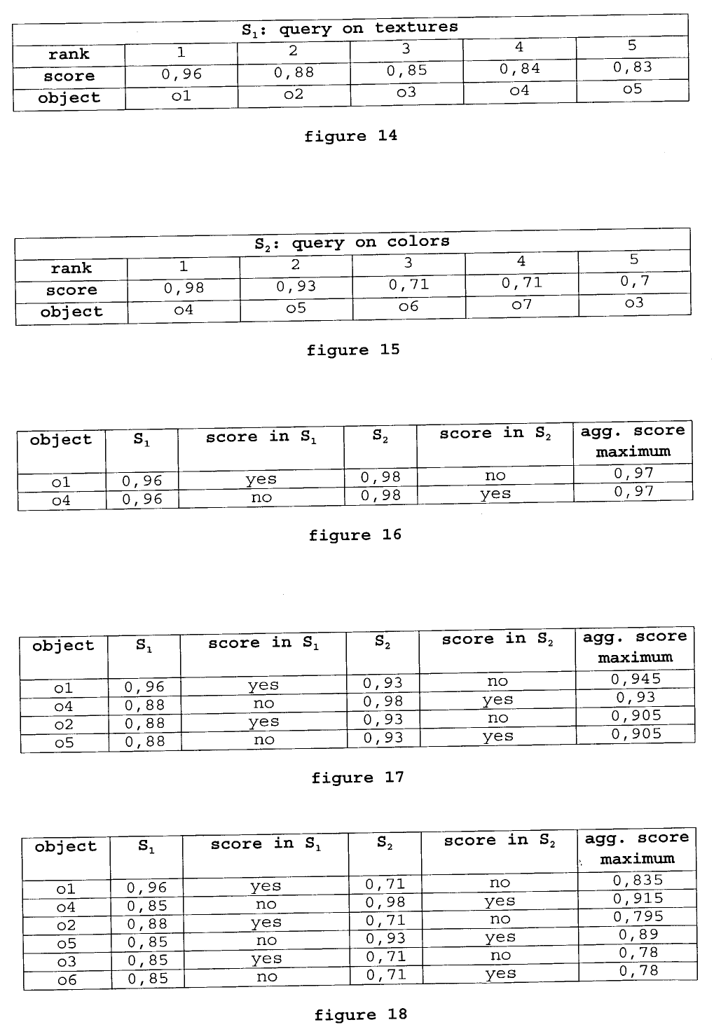

FIG. 14 shows a third data list for the texture characteristic,

FIG. 15 shows a third data list for the color characteristic,

FIG. 16 shows an access structure,

FIG. 17 shows an access structure widened once,

FIG. 18 shows an access structure widened twice,

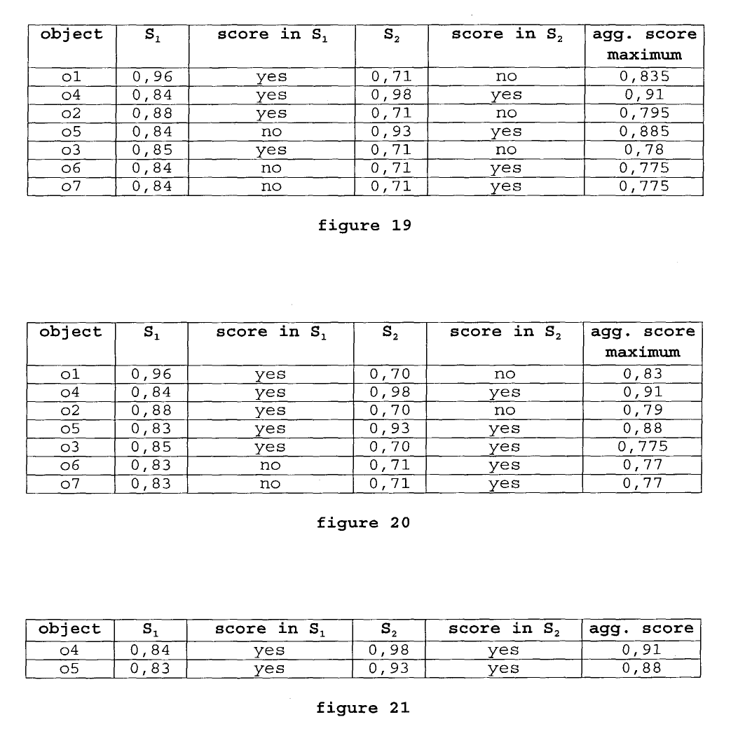

FIG. 19 shows an access structure widened three times,

FIG. 20 shows a results structure,

FIG. 21 shows a results list,

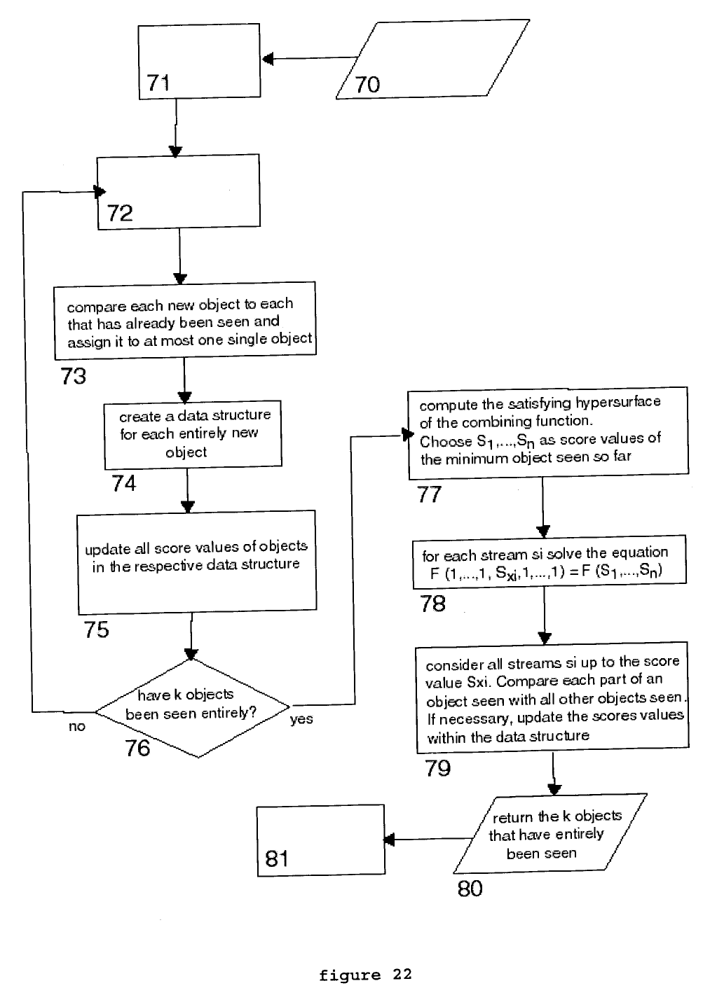

FIG. 22 shows a flowchart for a fourth method,

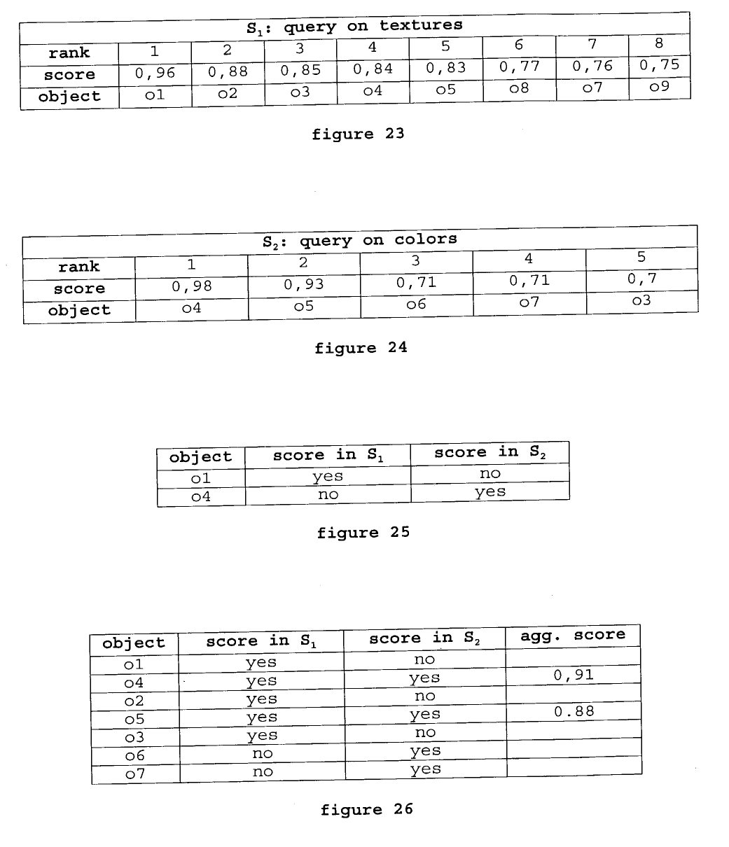

FIG. 23 shows a further data list for the texture characteristic,

FIG. 24 shows a further data list for the color characteristic,

FIG. 25 shows an access structure and

FIG. 26 shows a results structure.

FIG. 1 shows, as an example, an information system based on a database system, which is designated a Heron system and in which the method according to the invention is implemented. The information system is preferably implemented in the form of a computer system, the methods of determining the most similar objects preferably running automatically. The information system has an input/output device 1, which is preferably designed as a graphic user interface.

The input/output device 1 is connected to a search engine 2. The search engine 2 makes access to the database 3, which has a visual extender, a text extender and an attribute-based search system. The visual extender, the text extender and the attribute-based search system represent program blocks in which, for example, programs for color recognition, texture recognition, text recognition or Internet searches are stored.

Also provided is a selection device 4, which is connected to a data memory 6 and to the database 3. The selection device 4 is connected to a formatting device 5, which is in turn connected to the input/output device 1.

The information system according to FIG. 1 functions as follows: the object for which a search for similar objects is made and which is designated the sample object in the following text is input by the input/output device 1. The object is designated the sample object since it is used as a search pattern for the comparison with the objects to be checked. In this case, for example the characteristics of the object and the combination function with which the characteristics of the objects are assessed during the comparison are input. However, the object is not restricted to graphical samples but can represent any type of form or information.

For each characteristic which has been defined as a search criterion for the predefined object (sample object), the search engine 2 determines a data list from the database by using the program blocks comprising the visual extender, text extender and attribute-based search system. The program blocks indicated represent only examples. Those skilled in the art will use for the method of the invention the programs which are best suited for the search. In each data list, the objects are listed in sorted form in accordance with the value of the characteristic. The data lists and the predefined combination function F are output to the selection device 4 and stored in the data memory 6.

By using the data lists and the combination function F, the selection device 4 determines the predefined number of objects which most closely correspond to the predefined object (sample object). The predefined number of best objects is passed on by the selection device 4 to the formatting device 5, which prepares these in accordance with a predefined format and outputs them via the input/output device 1. The individual function blocks of FIG. 1 can also be implemented in the form of programs and/or electronic circuits.

FIG. 2 shows an example of data lists 12, 13 for the characteristics 1 to n. In a first data list 12, an identification OID for the objects is stored in a first column, the rank of the object within the data list is stored in a second column, and the value of the characteristic of the object is stored in a third column. The objects are arranged in a sorted manner in the data lists of the individual characteristics in such a way that the object with the greatest value is in the first rank, and the further objects are distributed to the further ranks in accordance with decreasing value.

FIG. 3 shows a flowchart of a first algorithm with which a search is made from a predefined set of objects for a predefined number of objects which best fit a predefined object (sample object) with predefined characteristics, without having to search through the entire database. In this method, direct accesses to the data in the database are largely avoided, so that the method can be carried out quickly and cost-effectively.

At program item 20, n characteristics and a combination function F for the predefined object, which is designated the sample object below, are input to the input/output device 1. The characteristics and the combination function can be defined freely. The characteristics are preferably defined on the basis of the sample object in such a way that a search is made for the characteristics of the sample object which best describe the sample object. Also, the combination function F is preferably defined in such a way that the more formative characteristics of the sample object are assessed more highly than the less formative characteristics.

Then, at program item 21, the search engine 2 determines from the database 3 for each input characteristic a data list corresponding to FIG. 2, in which the objects are listed in a manner sorted by decreasing value.

Then, at program item 22, the selection device 4 selects, from a first data list, the object with the greatest value of the characteristic which has not yet been selected for this characteristic, and stores the value of the characteristic with the identification OID of the object for the characteristic considered in a results list in the data memory 6.

At program item 23, the selection device 4 then checks whether all the characteristics to be considered and belonging to the object selected at program item 22 are already stored in the results list. If this is not so, then the selection device 4 determines all the unknown characteristics of the selected object at program item 24 by making direct access to the database 3. The characteristics of the selected object, determined from the database 3, are likewise stored in the results list.

Then, at program item 25, the selection device 4 calculates a value index S (aggregated score) for the selected object o in accordance with the following formula:

S(o)=F(s₁(o), . . . , sₙ(o))

where sᵢ designates the value of the object o for the characteristic i (1≦i≦n).

The combination function F consists, for example, of the arithmetic mean of the values of all the characteristics considered of the sample object, if these characterize the sample object equally strongly. The value index of the object is likewise entered in the results list in the data memory 6.

Then, at program item 26, the selection device 4 selects the object oₜₒₚ which has the greatest value index from the results list in the data memory 6.

Then, at program item 27, the selection device 4 calculates a comparison index V in accordance with the following formula:

V=F(s₁(r₁(z₁)), . . . , sₙ(rₙ(zₙ)),

where F designates the combination function, sᵢ the ith characteristic and rᵢ (zᵢ) the smallest value of the ith characteristic which is stored in the results list in the data memory 6 (1≦i≦n), and therefore is known to the selection device.

In the following program item 28, the selection device 4 compares whether the value index of the object with the maximum value index which is stored in the data memory 6 in the results list is larger than or equal to the comparison index V.

S(oₜₒₚ)≧V=F(s₁(r₁(z₁)), . . . , sₙ(rₙ(zₙ)))

If this is so, then at program item 29, the selection device 4 outputs this object via the formatting device 5 as the object with the greatest similarity to the predefined object. Then, at program item 30, the selection device 4 checks whether the predefined number k of best objects has been output. If this is so, then the program terminates. If it is not so, then a branch is made back to program item 22 and the program is run through again.

If the result of the query at program item 23 is that all the characteristics of the object o selected in program item 22 have already been stored in the results list of the data memory 6, then a branch is made directly to program item 27.

If the result of the query in program item 28 is that the value index of the object with the maximum value index is not greater than or equal to the comparison index V, then a branch is made back to program item 22, and the program sequence is run through again.

The progress of the first algorithm according to FIG. 3 will be explained in more detail below using a data example. In the example described, a best object in the database (k=1) is to be determined for a predefined image. The characteristics of the image which are used for the search are the texture and the color red of the predefined image (sample object). The combination function F used is the arithmetic mean of the two characteristics, since both the color and the texture of the sample object are equally strongly formative:

F(s₁(o),s₂(o))=(s₁(o)+s₂(o))/2.

FIG. 4 and FIG. 5 show the data lists which are determined from the database 3 by the search engine 2 in this example and are supplied to the selection device 4. The data list sᵢ of FIG. 4 represents a list of objects which have been sorted with decreasing value in accordance with the texture characteristic. The data list s₂ of FIG. 5 represents a list of objects which have been sorted with decreasing value by the color characteristic. The first, second, third, fourth, fifth, sixth and so on objects are designated by the identification OID o₁, o₂, o₃, o₄, o₅, o₆ and so on. In this example, the color to be compared is the color red and the texture to be compared is defined hatching or patterning.

First of all, then, the object o₁ is selected in accordance with program item 22. The result of the query in program item 23 is that the object o₁ is not known in the first three objects considered in the second data list s₂. Consequently, in accordance with program item 24, the value of the color characteristic for the object o₁ is determined via a direct access to the database 3. This is likewise carried out in an analogous way for the objects o₂, o₃, o₄, o₅, o₆. In each case, the values of the missing characteristics are determined by direct accesses to the database 3. The values of the objects which are determined from the database during the direct accesses are illustrated in FIG. 6. The access list is stored in the data memory 6 by the selection device 4.

The values of the characteristics for the first, the fourth, the second and the fifth object o₁, o₄, o₂ and o₅ are stored in the results list. The value indices (aggregated scores) are calculated from the values of the characteristics in accordance with program item 25 and stored in the results list in the data memory 6 in accordance with FIG. 7.

Before the evaluation of the fifth object o₅, the query at program item 28 has always resulted in the value index of the object S(oₜₒₚ) with the maximum value index (aggregated score), which is stored in the results list, being smaller than the comparison index V. Therefore, a branch has always been made back to program item 22 again.

Following the evaluation of the object o₅, the object o₄ is selected at program item 26 as the object with the maximum value index (aggregated score), the value index having the value 0.91. Then, according to program item 27, the comparison index V is determined:

V=F(s₁(r₁(z₁)), . . . , sₙ(rₙ(zₙ))),

V=F(s₁(o₂),s₂(o₅))=(s₁(o2)+s₂(o₅))/2=0.905.

Then, at program item 28, the value index of the object o4 is compared with the comparison index V and it is established that S(o4)>V.

Therefore, according to program item 29, a branch is made and the fourth object o4 is output as the object which best fits the predefined object. In the following program item, it is established that with k=1, all k objects have been output and the program terminates.

A second algorithm for determining similar objects is illustrated in FIG. 8 using a flowchart. The second algorithm permits a particularly efficient method of determining a predefined number k of objects which best fit a predefined object.

At program item 31, for a sample object for which a search is made for similar objects, n predefinable characteristics and a predefinable combination function F are input via the input/output device 1. The sample object, the n characteristics and the combination function F correspond to those of the first algorithm according to FIG. 3.

Then, at program item 32, the search engine 2 in each case determines a data list for the texture and color characteristics from the database 3, said list being illustrated in FIGS. 9 and 10. The objects are listed in the data lists sorted by decreasing value, and the data lists are supplied to the selection device 4.

In the following program item 33, the selection device 4 in each case selects the two objects with the highest values from the two data lists and stores the identification of the objects with the values for the characteristics in the data memory 6 in a results list. Instead of the two objects, a different number p of objects can also be selected. The optimum number p will be determined by those skilled in the art depending on the application.

The selection device 4 then calculates an indicator for each data list, the indicator designating the gradient with which the value of the characteristics falls over the number of objects. For this purpose, only those objects which are stored in the results list are taken into account. For the first data list (FIG. 9), the result is a first indicator I1: I1=0.5*(0.96−0.88)=0.04. For the second data list (FIG. 10), the result is a second indicator I2: I2=0.5(0.98−0.93)=0.025.

Since the weights can be expressed in the combination function F (for example a weighted arithmetic mean), a simple measure of the indicator of each data list is the partial derivative of the combination function δF/δxᵢ. Thus, in the weighted case, an indicator Iᵢ for each data list which contains more than p elements may be calculated as follows:

Iᵢ=δF/δxᵢ*(sᵢ(rᵢ(zᵢ−p))−sᵢ(rᵢ(zᵢ)))

Then, at program item 34, the selection device 4 checks whether all characteristics of the objects whose identifications are stored in the results list are known. If this is so, then at program item 35, the comparison index V is calculated in accordance with the following formula:

V=F(s₁(r₁(z₁)), . . . , sₙ(rₙ(zₙ)),

F designating the combination function, sᵢ the ith characteristic and rᵢ (zᵢ) the smallest value of the ith characteristics (1≦i≦n), which value is stored in the results list in the data memory 6 and is therefore known to the selection device.

Then, at program item 36, the selection device calculates the value indices S (aggregated score) for the objects o from the results list in accordance with the following formula:

S(o)=F((s₁(o), . . . , sₙ(o))

where sᵢ designates the value of the object o for the characteristic i (1≦i≦n) and F designates a combination function which, in this example, represents the arithmetic mean of the values of the objects. The selection device 4 then compares the objects which are stored in the results list to see whether the value index S of k objects of the results list are greater than or equal to the comparison index V.

| [symbol] o|S(o)≧F(s₁(r₁(z₁)), . . . ,sₙ(rₙ(zₙ))) [symbol] |≧k

If this is so, then at program item 37, the selection device 4 outputs the k objects with the best value indices via the formatting device 5 to the input/output device 1 as the result. The program then terminates.

If the result of the query at program item 34 is that not all of the characteristics of the objects specified in the results list are known, then at program item 38, the missing characteristics are next determined by the selection device 4 by direct accesses to the database 3 and are stored in the results list. The results of the direct accesses are illustrated in the access list of FIG. 11, which is stored in the data memory 6.

Then, at program item 39, the selection device 4 calculates the value index S(o) (aggregated score) for each object o and stores this value index in the results list. FIG. 12 shows the value indices of the results list. A branch is then made to program item 35.

If the result of the query at program item 36 is that the value index of k objects is not greater than or equal to the comparison index V, then at program item 40, the object with the greatest value which has not yet been selected from the data list (program item 33, program item 40) is selected from this data list with the lowest indicator by the selection device 4, and stored in the results list.

Then, at program item 41, the comparison index V is recalculated by the selection device 4, taking into account the object just newly selected.

In the following query at program item 42, a check is made to see whether the value index S(o) of k objects of the results list is greater than or equal to the comparison index V. If this is so, a branch is made to program item 37. If this is not so, then in the following program item 43, the indicator is recalculated for the data list from which the new object was selected at program item 40. A branch is then made to program item 34.

The second algorithm exhibits an increase in efficiency as compared with the first algorithm. As a result of the double evaluation of the termination condition, fewer direct accesses are necessary. In addition, in the selection of new objects which are taken into the results list, by means of selecting the data list which has the greatest indicator I, the k best objects are determined very quickly. This effect is based on the fact that the probability that the comparison index V with an object from the data list with a large indicator rapidly becomes smaller is greater than in the case of an object from a data list with a small indicator.

In the following text, the program sequence of FIG. 8 will be explained in more detail using an example: FIGS. 9 and 10 show the two data lists which the search engine 2 determines from the database 3 and provides to the selection device 4 at program item 32. At program item 33, the objects o1, o2, o4 and o5 are selected by the selection device 4 and stored in the data memory 6 with the values (score).

Since not all the characteristics are known, in accordance with program item 38, the missing characteristics have to be searched for by the selection device 4 via direct accesses to the database 3. The result of the direct accesses is illustrated in FIG. 11.

From the now completely known characteristics to the objects, according to program item 39, the selection device 4 calculates the respective value index S (aggregated score) of the objects and stores these in a results list in the data memory 6, corresponding to FIG. 12.

The termination condition can then be evaluated in accordance with program item 35 by using the comparison index V which is stored for each characteristic in the results list. Since the data lists are sorted, the lowest values are possessed by the objects which have been selected last from the data lists: that is to say, here, the objects o2 and o5: the comparison index is therefore calculated as follows:

V=F(s₁(r₁(z₁)), s₂(r₂(z₂)))=F(s₁(o2), s₂(o5))=0.905.

The result of the query at program item 36 is that the set of objects with a value index S (aggregated score) ≧ comparison index V consists only of a single object, namely the object o4. There is therefore no termination.

The results list must therefore be widened at program item 40. For this purpose, an object which has the greater indicator is fetched from the data list, in this case from the data list s₁. The next object in the data list s₁ which has not yet been read from this data list and is now read is the object o3 with a value s₁(o3) of 0.85. The new minimum values of the two results lists therefore supply the following value for the comparison index V at program item 41:

V=F(s₁(r₁(z₁)), s₂(r₂(z₂)))=F(s₁(o3), s₂(o5))=0.89.

The result of the query at program item 42 is that only the object o4 has a value index greater than or equal to the comparison index V. The condition in the query at program item 42 is therefore not satisfied and a branch is made to program item 43.

At program item 43, a new indicator I₁=0.5 * (0.88−0.85)=0.15 is calculated for the data list s₁ and a branch is then made to program item 34.

At program item 34, a direct access must be made for the object o3: s₂(o3)=0.7, and the value index S(o3) for the object o3 must be calculated: S(o3)=0.775.

The query at program item 36 is again not answered with a yes, since only the object o4 has a greater value index than the comparison index V (V=F(s₁(o3), s₂(o5))=0.89).

Then, at program item 40, a new object with the greatest value is again loaded from a data list into the results list. This time, the data list s₂ has the greater indicator. Consequently, object o6 with a value s₂(o6)=0.71 is taken into the results list, since the object o6 has not yet been read from the data list s₂.

The minimum scores in the streams are now s₁(o3) and s₂(o6) and therefore F(s₁(o3), s₂(o6))=0.78 for the query at program item 42. There are now more than k (k=2), that is to say two objects, which have a greater value index, specifically the objects o4, o5 and o1.

A branch is then made to program item 37, and the objects o4 and o5 are output as the best objects from the entire database.

FIG. 13 shows a flowchart of a third algorithm for determining k objects which best resemble a predefined object (sample object), which is characterized by n characteristics. Again, use is made of a combination function F with which the characteristics are assessed for the comparison of the objects with the sample object.

At program item 50, the n characteristics and the combination function F for the predefined object are input via the input/output device 1. The n characteristics are, for example, determined in advance in an analysis of the sample object. In this case, any combination function F can be used. In this example, the predefined object, the predefined characteristics and the combination function F correspond to those of the first algorithm according to FIG. 3.

At program item 51, the search engine 2 in each case determines a data list for the texture and color characteristics from the database 3, said lists being shown in FIGS. 14 and 15. The values of the characteristics of the objects are listed in a manner sorted by decreasing value. The data lists are supplied to the selection device 4.

At program item 52, the selection device 4 selects from the data lists supplied a predefined number m of values from each data list which represent the greatest values in the data list and which have not yet been written into the results list. The selected values are stored in the results list in the data memory 6 together with the associated characteristics and identifications of the objects.

In the following program item 53, the selection device 4 compares the newly selected objects with each of the objects for which values are already stored in the results list and decides which objects are identical. This check is necessary in particular in heterogeneous information systems, in which an assignment of the objects from the various data lists via the identification of the objects is not unambiguously possible. The comparison of the objects is carried out in accordance with known methods, which are described for example by W. Cohen in “Integration of Heterogeneous Databases without Common Domains Using Queries Based on Textual Similarity”, Proceedings of ACM SIGMOD '98, Seattle 1998.

At program item 54, a new access structure corresponding to FIG. 16 is created for each new object for which no values have yet been stored in the results list.

At program item 55, the values of the characteristics for all the newly selected objects are stored in the results list in the data memory 6. In addition, for each object the values of characteristics which have not yet been registered are estimated with the lowest value of the characteristic that has previously occurred. The value index (aggregated score) is then calculated with the combination function F and entered into the access structure.

At program item 56, the selection device 4 checks whether k objects are completely known, that is to say whether k objects have values which have actually been determined for all the characteristics to be considered and not estimated values for the characteristics. If this is not so, a branch is made back to program item 52.

However, if the result of the query in program item 56 is that k objects are already completely known in terms of the characteristics considered, then a branch is made to program item 57.

At program item 57, all that data is removed from the results list which refers to the objects which have a value index S in which at least one estimated value of a characteristic has been taken into account and which, in addition, is less than or equal to the value index of the smallest completely known object. Should values for all characteristics have been stored in the results list for k+1 objects, that is to say k+1 objects are completely known, then the object with the smallest value index is also removed from the results list. A branch is then made to program item 58.

At program item 58, a check is made to see whether more than k objects have been stored in the results list. If this is not so, then at program item 59, the k completely known objects are output to the input/output device 1 by the selection device 4, via the formatting device 5, as the k objects which best resemble the predefined object.

If the result of the query at program item 58 is that more than k objects are known, then a branch is made to program item 60.

At program item 60, the selection device 4 selects from all the data lists a predefined number of new objects which have the highest values for the data list (characteristics) and which have previously not been selected for this data list (characteristic). At program item 61, in a manner analogous to program item 53, the values of the newly selected objects are assigned to an object via a predefinable comparison function and written into the results list in the data memory 6. The values of the characteristics of the newly selected objects which cannot be assigned to an object already stored in the results list are discarded and not used further.

By using the values of the characteristics newly stored at program item 61, the unknown values of the characteristics of the objects stored in the results list are estimated in accordance with program item 55 by using the known, minimum values of the characteristics and are entered in the results list. At the same time, by using the values newly written into the results list, the value indices S are calculated in accordance with program item 55.

In program items 60, 61 and 57, no new objects are entered in the results list, instead only new values of objects already stored in the results list are fetched from the data lists and used for the further estimation. A branch is then made to program item 57.

In the following text, the third algorithm according to FIG. 13 will be explained in more detail using an example: in the example described, two objects (k=2) are to be found in the database which best fit a predefined object with predefined texture and color characteristics and the combination function F. The combination function F is the arithmetic mean of the texture and the color. The predefined object with the predefined characteristics and the combination function corresponds to the predefined object from the first algorithm.

FIGS. 14 and 15 illustrate the data lists which are provided to the selection device 4 from the database 3 at program item 51.

At program item 52, the object o1 and o2 with the respective greatest value of the characteristic texture or color is entered in the results list. Here, the identification and the value of the characteristic are entered for each object. The objects o1 and o4 are then processed in accordance with program items 53, 54 and 55 and the value index S (aggregated score) is written into the access structure in accordance with FIG. 16.

The result of the query in program item 56 is then that k objects are still not yet completely known. Consequently, the further two objects o2, o5 are fetched from the data lists of FIGS. 14, 15 at program item 52 and entered in the results list with the identification and the value of the characteristic. By processing program items 53, 54 and 55, the value index S for each object is calculated and written into the access structure according to FIG. 17.

The result of the query at program item 56 is again that k objects are not yet completely known. To this extent, at program item 52, the further objects o3, o6 are fetched from the data lists and entered in the results list together with the identification and the values for the characteristics. In accordance with the program items 53, 54 and 55, the value index S is calculated for the newly selected objects and written into the access structure according to FIG. 18.

The result of the following query at program item 56 is again that k objects are not completely known, so that again a branch is made to program item 52 and the object o4 from the first data list (FIG. 14) and the object o7 from the second data list (FIG. 15) are selected and written into the results list with the values for the characteristics. Program items 53, 54 and 55 are then processed, the value indices X for the object o4 and o7 are calculated and written into the access structure according to FIG. 19.

Although the result of the following query at program item 56 is that an object o4 is completely known, since two best objects (k=2) are to be determined, again not all the k objects are completely known, so that a branch is made back to program item 52.

At program item 52, firstly the object o5 is read from the first data list (FIG. 14) and the object o3 is read from the second data list (FIG. 15) and entered in the results list together with the characteristics. By processing the program items 53, 54 and 55, the value indices S for the object o5 and o3 are calculated again and written into the access structure according to FIG. 20.

The result of the following query at program item 56 is that three objects (o4, o5, o3) are completely known in the results list. A branch is therefore made to program item 57. At program item 57, those objects are removed in which the value index (aggregated score) has been determined at least with one estimated value and the value index is less than the smallest value index of a completely known object. In this case, all the objects apart from objects o4 and o5 are removed from the results list.

There therefore remain the objects o4, o5 as the objects which, following processing of program items 58 and 59, are output as a result of the query.

One advantage of the third algorithm is that, in particular in heterogeneous information systems, time-consuming direct accesses are avoided. As a result, a faster search algorithm is implemented.

In the following text, a fourth algorithm will be described with which a search can be made in an efficient manner for objects which best resemble a predefined object (sample object).

The fourth algorithm substantially comprises two phases. In the first phase, new objects are written into the results list and compared with the other objects. As in Fagin's algorithm, a start can be made with the second phase preferably after the occurrence of the first k elements for all the characteristics in the results list. However, as opposed to Fagin's algorithm, in this phase no time-consuming direct accesses to the objects in the database have to be carried out, instead it is merely necessary for the results list for the characteristics to be widened further with objects up to specific, geometrically estimated limiting values, for the objects to be compared with one another and for the value indices to be calculated in order to guarantee correctness of the best objects.

The estimation of the limiting values Sₓᵢ is determined geometrically by calculating a level hypersurface of the combination function F. For this purpose, n equations:

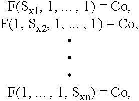

have to be solved, C₀=F(S₁, . . . ,Sₙ) with (S₁, . . . ,Sₙ) designating the inner corner of the cuboid which encloses the k first objects to be considered completely. These equations can be solved for virtually all the combination functions used in practice, such as weighted arithmetic means, in the interval [0,1]ⁿ. Again, a results list and an access structure are needed, as in the third algorithm.

The values (S₁, . . . ,Sₙ) correspond to the values of the characteristics of the object of the results list which has the smallest value index and from which all values of the characteristics are known. In another embodiment, the values (S₁, . . . ,Sₙ) correspond to the smallest values of the characteristics which are stored in the results list, that is to say the smallest known values of the characteristics. The value C₀ corresponds to the value index (aggregated score) of the smallest object whose characteristics are all known and are stored in the results list.

Without having to make direct access to the database each time, the object which has newly occurred in the results list is compared with the objects that have previously occurred for the other characteristics in the results list, which substantially corresponds to a main memory operation of low complexity. If k objects have already occurred for all the other characteristics in the results list, as a second step, depending on the combination function F for all the characteristics, those objects whose value indices are greater than the value indices of the previously calculated limiting values Sₓ₁ to Sₓₙ have to be loaded from the data lists into the results list.

The objects newly written into the results list are then compared with the objects already stored. All the objects which are known in the results list for all the characteristics are ordered in accordance with their value indices, and the first k objects can be output as the result of the search.

FIG. 22 shows a flowchart of the fourth algorithm, with which a predefined number k of objects which best resemble a predefined object (sample object) is determined from a database.

At program item 70, n predefinable characteristics and a combination function F for the predefined object (sample object) are input via the input/output device 1. The predefined object, the predefinable characteristics and the combination function F correspond to those from the second algorithm according to FIG. 3.

Then, at program item 71, the search engine 2 in each case determines a data list, which is illustrated in FIGS. 23 and 24, for the texture and color characteristics from the database 3. The objects are sorted by descending value of the characteristics. The data lists are supplied to the selection device 4.

At program item 72, the selection device 4 selects from the data lists supplied a predefinable number m of objects from each data list which have the greatest values of the data list (characteristics) and whose values for this data list have not yet been entered in a results list in the data memory 6. The values of the characteristics and the identifications of the objects are then stored in the results list in the data memory 6.

In the following program item 73, the selection device 4 compares the object identifications newly entered in the results list with each of the object identifications already stored in the results list and decides, via a comparison function, which object identifications from different data lists belong to a single object. The comparison is carried out with the same function as in program item 53 of the third algorithm in FIG. 13.

This comparison is necessary in particular in heterogeneous information systems, since in the case of these information systems, an assignment of the objects to one another via the identification is not provided unambiguously from the start.

At program item 74, for each new object for which no values have yet been stored in the results list, a new access structure corresponding to FIG. 25 is created, in which the identification of the object and the information as to which characteristic of the object is known are stored.

At program item 75, the selection device 4 writes all the values of the characteristics of the new object, newly read in program item 73, into the access structure.

The selection device 4 then checks, in program item 76, whether values are known for k objects in all the characteristics to be considered. If this is not so, a branch is made back to program item 72.

If the result of the query in program item 76 is that all the values of the characteristics considered are known for k objects in the results list, that is to say k objects are completely known, then a branch is made to program item 77. Instead of the number k, a different number can also be used as a criterion in order to branch to program item 77.

At program item 77, the selection device 4 determines the value limits by forming a level hypersurface in order to be sure that sufficient objects are considered, in order that a reliable statement about the best objects can be made. For this purpose, the selection device 77 selects the values of the object stored in the results list and having the smallest value index in order to determine the sufficient level hypersurface. Then, at program item 78, for the values of the selected smallest object, the system of equations described above and having n equations is solved for the combination function F.

Then, at program item 79, all the objects from the data lists up to the associated value Sₓᵢ are selected by the selection device 4, and the objects with the values greater than the limiting value Sₓᵢ are written into the results list. In the process, in accordance with program item 73, the objects newly written in are compared with the objects previously seen and each object is assigned unambiguously to an object.

Then, at program item 80, the selection device 4 determines from the objects stored in the results list the k best completely known objects and, at program item 81, outputs these via the formatting device 5 and the input/output device 1 as the k best objects.

In the following text, the fourth algorithm according to FIG. 22 will be explained in more detail by using a numerical example: FIG. 23 shows a data list for the texture characteristic, and FIG. 24 shows a data list for the color characteristic, which are determined by the search engine 2 and transferred to the selection device 4.

In this exemplary embodiment, the two best objects in the database are to be found (k=2) which, in relation to the texture and the color, best fit a predefined object, which corresponds to the object from the first algorithm of FIG. 3.

In accordance with program items 72 to 76, the objects o1 and o4 are read successively from the data lists of FIGS. 23, 24 and written into a results list in the data memory 6. Stored in the results list is the identification of the object and the value of the characteristic of the object. In addition, an access structure corresponding to FIG. 25 is stored in the data memory 6. Stored in the access structure are an identification for the object, the value index (aggregated score) of the object and the information as to which characteristic of the object is known.

Since k objects are not yet completely known, the result of the query at program item 76 is that a branch back to program item 72 is made and further objects are alternately selected from both data lists and processed in accordance with program items 73, 74 and 75 and written into the data memory 6, until the values for the texture and color characteristics have been stored in the results list for k objects. FIG. 26 shows this status by using the access structure. It can be seen from FIG. 26 that the characteristics of the objects o4, o5 are known completely, so that following the program query at program item 76, a branch is made to program item 77.

The sufficient level line can accordingly be determined at program item 78. For this purpose, as described above, the n equations for the combination function F have to be solved.

For the exemplary embodiment described, the following values result:

½(Sₓ₁+1)=0.88 and

½(1+Sₓ₂)=0.88,

the value 0.88 for Co being the value index (aggregated score) of the object o5, which represents the object in the results list which has the smallest value index and whose values are known for all characteristics.

As a result, it follows that: Sₓ₁=Sₓ₂=0.76.

It follows from this that, in the following program item 79, all objects with values greater than 0.76 from both data lists have to be written into the results list and have to be taken into account when searching for the best objects.

From the data list s₂, the object o7 with the value 0.71 has already been written into the results list, that is to say no further objects from this data list have to be taken into account. Only in the data list s₁ may there still be a corresponding object which has to be taken into account. The next object o8 in the data list s₁ has a value of 0.77. However, since it has not occurred up to the value 0.76 in the data list s₂, it can be discarded. The following object o7 has the value 0.76. Since the object o7 has already been transferred from the data list s₂ into the results list, its value index S must become: S=0.735. The value index of object o7 is therefore less than the value indices of o4 and o5. The object o7 can therefore not belong to the two best objects. The next object from s₁ is the object o9 with a value of 0.75 and therefore lies outside the limit of 0.77 which was calculated via the level hypersurface. The object o9 therefore no longer has to be taken into account.

Therefore, in both data lists, as far as the value 0.76 we have seen only three objects completely, of which the two best (o4, o5) can be output at program item 81 as the best two objects from the entire database.

The methods according to the invention are preferably stored on a storage medium which can be read by a computer, so that the computer can execute the methods. One simple implementation of the apparatus for carrying out the methods consists in a computer which has the program blocks illustrated in FIG. 1 implemented either in hardware and/or in software.

Depending on the sample object and the type of information systems predefined, the combination function F can be optimized in order to obtain the best possible search result. The combination function permits weighting of the characteristics, which can be input individually.

1. A method of determining from a large number of objects a predefinable number k of objects which best resemble a predefined sample object with regard to a plurality of characteristics, in which a combination function for assessing the characteristics is predefined, a number of objects whose values are greatest for the characteristic being selected for each characteristic, characterized in that,
for each selected object, a value index is calculated by using the values of the characteristic and the combination function, and in that for the selection of the most similar objects, only those objects whose value index lies above a predefinable comparison index are considered.

2. A method of determining from a large number of objects a predefinable number k of objects which best resemble a predefined sample object with regard to a plurality of characteristics, a combination function for assessing the characteristic being predefined, for each characteristic a number of objects being selected whose values for the characteristic are greatest, characterized in that,
for each selected object, a value index is calculated by using the value of the characteristic and the combination function,
in that by using the value of the characteristic of the selected objects and the combination function, a limiting value for the value of the characteristic is calculated,
and in that for the further selection of the most similar objects, the objects from the large number of objects and from the set of selected objects are considered whose value of the characteristic lies above the calculated limiting value.

3. The method as claimed in claim 2, characterized in that in order to calculate the limiting value, the values of the characteristics of the selected object which has the smallest value index are used.

4. The method as claimed in claim 3, characterized in that in order to calculate the limiting values (Sₓᵢ), the following system of equations with n equations for the combination function F is solved: 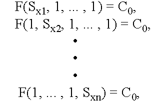
where C₀=F(S₁, . . . , Sₙ) and the values (S₁, . . . , Sₙ) correspond to the values of the characteristics of the selected object which has the smallest value index or the values (S₁, . . . , Sₙ) correspond to the smallest values of the characteristics which have been stored in the results list.

5. The method as claimed in claim 1, characterized in that the comparison index is calculated with the combination function, the respective smallest value of a characteristic which has occurred in the selected objects being used.

6. The method as claimed in one of claims 1 to 5, characterized in that for the selected objects for which a value of a characteristic is not yet known, an estimate is made by means of the smallest value of the characteristic which a selected object has.

7. The method as claimed in one of claims 1 to 6, characterized in that the number of selected objects whose values of the characteristics are completely known corresponds at least to the number k of objects sought before a decision about the best objects is made.

8. A method of determining from a large number of objects a predefinable number k of objects which correspond to a predefined sample object with the greatest similarity with regard to a plurality of characteristics, a combination function being predefined for the assessment of the characteristics, having the following method steps:
1) for each characteristic, a predefinable number of objects is selected which have the highest values for the characteristic,
2) for each selected object, the values of the characteristics which are not yet known for the object are determined,
3) for each selected object, by using the values of the characteristics, a value index is determined with the combination function F,
4) the value indices of the selected objects are compared with a predefined comparison index,
5) the objects whose value indices is greater than the comparison index are output as the result,
6) if, following this comparison, k objects have not yet been output, then for a characteristic a new object is selected which has the greatest value of the characteristic and which has not yet been selected for this characteristic, and the procedure is then continued with method step 2,
7) method steps 2 to 7 are executed until k objects are known whose value indices is greater than the comparison index.

9. The method as claimed in claim 8, characterized in that for all the characteristics, the respectively smallest value of a selected object is determined, and in that the comparison index is determined with the combination function by using the smallest values.

10. The method as claimed in either of claims 8 and 9, characterized in that for each characteristic a change value is determined which represents a measure of the decrease in the value of the characteristic over the sequence of the objects, and in that in method step 7, from the characteristic, a new object which has the greatest change value and has not yet been selected for this characteristic is selected.

11. The method as claimed in one of claims 8 to 10, characterized in that,
after method step 7 and before method step 2, the smallest values of the selected objects are determined for the characteristics,
in that from the determined smallest values of the characteristics, by using the value of the newly selected object, a comparison index is determined with the combination function,
in that the value indices of the selected objects are compared with the comparison index,
in that the objects whose value indices is greater than the comparison index are output as the result and
in that processing continues with method step 2 if k objects have not yet been output.

12. A method of determining from a large number of objects a predefinable number k of objects which correspond to a predefined sample object with the greatest similarity with regard to a plurality of characteristics, a combination function being predefined for the assessment of the characteristics, having the following method steps:
1) for each characteristic, a predefinable number of objects is selected which have the highest values for the characteristic,
2) for each selected object, all the predefined characteristics which have not been found in method step 1 are estimated by using the lowest value which a selected object has for the corresponding characteristic,
3) for each selected object, by using the values for the known and the estimated characteristics, a value index is determined in accordance with the combination function,
4) if a number k of objects is known in terms of all characteristics, then those objects are discarded of which at least one value of a characteristic is estimated and whose value index is less than the smallest value index of a known object, and a branch is then made to method step 6,
5) if a number k of objects is not known in terms of all characteristics, then a new object for at least one characteristic is selected and a branch is made to method step 2,
6) if a number of k objects is known in terms of all characteristics, then a new value of a characteristic which is greatest for the characteristic and has not yet been selected is selected, a check is then made to see whether the object whose value has been selected has already been selected for another characteristic, if this is so, then the procedure is continued with program step 7, if this is not so, then the newly selected value is discarded and method step 6 is repeated,
7) if, during the expansion according to method step 6), all the values of the characteristics of a selected object are known, then the completely known object with the smallest value index is discarded,
8) furthermore, that object is removed whose value index is not completely known and whose value index is less than the smallest value index of the objects whose values are known for all characteristics,
9) method steps 6 to 8 are run through until for k selected objects, all characteristics are known without estimated values and whose value indices are greater than the largest value index of an incompletely known object.

13. A method of determining from a large number of objects a predefinable number k of objects which correspond to a predefined sample object with the greatest similarity, at least one characteristic being predefined for the sample object and a combination function being predefined for the assessment of the characteristic, having the following method steps:
1) for each characteristic, a predefinable number of objects is selected which have the highest values for the characteristic, until at least the number k of objects are known in terms of all the characteristics considered,
2) for each selected object, by using the values for the characteristics, a value index is determined with the combination function,
3) the smallest object with the smallest value index is determined,
4) from the values of the characteristics of the smallest object or from the smallest values of the characteristics stored in the results list, limiting values for the characteristics are determined via the combination function,
5) all objects whose values for the characteristics lie above the limiting values are additionally selected,
6) from the selected objects, the number k of objects whose value index are the greatest is selected.

14. An apparatus, in particular a computer system, for carrying out a method as claimed in one of claims 1 to 13.

15. A storage medium which contains data which can be read and executed by a computer, characterized in that the data describes a method as claimed in one of claims 1 to 13.
